(19) United States
(12) Patent Application Publication
(10) Pub. No.: US 2004/0100316 A1
(43) Pub. Date: May 27, 2004

(54) Semiconductor circuit having repeaters in a signal transmission line

(75) Inventor: Hiroshi Yamamoto, Kanagawa (JP)

Correspondence Address: YOUNG & THOMPSON, 745 SOUTH 23RD STREET 2ND FLOOR, ARLINGTON, VA, 22202

(73) Assignee: NEC ELECTRONICS CORPORATION, KANAGAWA (JP)

(21) Appl. No.: 10/701,557

(22) Filed: Nov. 6, 2003

(30) Foreign Application Priority Data
Nov. 6, 2002 (JP) 2002-322546

(51) Int. Cl. G06F 1/04

(52) U.S. Cl. 327/291

(57) ABSTRACT

A plurality of repeaters are inserted in a signal transmission line connecting together two functional blocks in a semiconductor device, wherein each of the repeaters includes first and second inverters cascaded in this order along the direction of signal transmission in the signal transmission line. The first inverter has a higher current driveability than the second inverter for achieving a smaller overall signal propagation delay.

### BACKGROUND OF THE INVENTION

(a) Field of the Invention

The present invention relates to a semiconductor device having repeaters in a signal transmission line and, more particularly, to an improvement of the repeater to achieve a reduced signal propagation delay.

(b) Description of the Related Art

In the design of LSIs, such as a system LSI, the whole circuit configuration of the LSI is generally divided into a plurality of functional blocks, followed by designing the circuit configuration of each of the functional blocks and connecting together the plurality of functional blocks via signal transmission lines to obtain the whole circuit configuration. In general, the designed LSI is verified for the operation thereof by using a circuit simulator, which simulates propagation delays of signals transferred through the signal transmission lines.

If the simulation using the circuit simulator detects that the propagation delay of a signal transferred by a signal transmission line exceeds a desired range, a repeater is generally inserted in the signal transmission line for reducing the signal propagation delay. Such a repeater may have a logic non-inverting function or logic inverting function. For example, a buffer including a pair of cascaded inverters and thus having a logic non-inverting function is used as a typical repeater in a CMOS LSI. The signal propagation delay increases in proportion to the product of the line resistance and the line capacitance, and is expressed by the quadric function of the length of the signal transmission line. Thus, a plurality of repeaters inserted in the signal transmission line at a constant pitch, for example, reduces the signal propagation delay by dividing the signal transmission line into a plurality of divided signal lines.

FIG. 7 shows the relationship between the signal propagation delay and the length of a signal transmission line, wherein graph (a) represents a propagation delay of the signal transmission line having a length of 10 mm, graph (b) represents a propagation delay when a repeater is inserted in the 10-mm-long signal transmission line at the central position thereof, and graph (c) represents a propagation delay when two repeaters are inserted in the 10-mm-long signal transmission line at a constant pitch.

The overall signal propagation delay of the signal transmission line including therein inserted repeaters is the total of a sum of propagation delays of divided signal lines and a sum of the operational delays of the repeaters. The operational delay of the repeater depends on the rising or falling edges of the input signals having respective rise times or fall times, a current driveability (driveability) of the repeater, as well as the line capacitance of the divided signal line and the input capacitance of the succeeding-stage repeater which are connected to the output of the repeater. The slope of the rising or falling edge of the input signal for the repeater depends on the line length between the repeater and the preceding repeater, the input capacitance of the repeater and the driveability of the preceding-stage repeater.

As understood from FIG. 7, graph (a) shows the propagation delay increasing in proportion to the square of the line length. When the 10-mm-long signal transmission line is divided by a single repeater into two 5-mm-long divided signal lines, as shown by graph (b), the sum of propagation delays of the divided signal lines reduces to a value significantly lower than the propagation delay of the 10-mm-long signal transmission line shown by graph (a), although the operational delay of the repeater is added thereto.

Comparing graph (b) against graph (a), it will be understood that the reduction of the signal line's delay by the division of the 10-mm-long signal transmission line into two lines by insertion of a single repeater at the central position thereof exceeds the delay added by the inserted repeater. In this example, insertion of the single repeater in the 10-mm-long signal transmission line reduces the overall propagation delay by a time length Δtpd.

If two repeaters are inserted in the 10-mm-long signal transmission line at a constant pitch, as shown by graph (c), the overall propagation delay is increased compared to the case of the insertion of the single repeater as shown by graph (b), although some improvement is recognized from the case of insertion of no repeater as shown by graph (a). This is because increase of the operational delays of the repeaters by reducing the pitch of the repeaters exceeds the decrease of the propagation delays of the divided signal lines due to the decrease of the line length thereof. Thus, it is important to suitably design the number of repeaters to be inserted in the signal transmission line.

Patent Publication JP-A-2001-290854 describes a technique for optimizing the number of buffers including two cascaded inverters, i.e., repeaters, and the number of branches from the output of each repeater, by using a specified formula. The described technique proposes to obtain optimum number (N_{bf}) of cascaded buffers to be inserted and optimum driveability ratio (h_{bf-out}) between an output-stage inverter and a unit-size inverter in the repeater, by calculating the overall propagation delay of the signal transmission line including the inserted buffers while using the following formula:

$$\begin{matrix}{t}_{d \text{-} b f} = ( a \cdot {b}_{r} \cdot {R}_{o u t0} \cdot {C}_{i n t} \cdot {1}_{i n t} ) / {h}_{b f \text{-} o u t} + \\ \{ ( d / m ) \cdot {R}_{i n t} \cdot {1}_{i n t} \cdot {C}_{i n 0} \} \times {h}_{b f \text{-} o u t} + \\ [ b \cdot \{ m + ( {b}_{r} / m ) + 2 \cdot ( {C}_{d s0} / {C}_{i n0} ) \} \cdot {R}_{o u t0} \cdot {C}_{i n0} ] \times {N}_{b f} + \\ ( C \cdot {R}_{i n t} \cdot {C}_{i n t} \cdot {1}_{i n t}^{2} ) / {N}_{b f} ,\end{matrix} \qquad ( 1 )$$

wherein a, b, c and d are coefficients, Rₒᵤₜ₀ is the output resistance of a standard-size inverter having a specified channel ratio, i.e., a specified ratio of channel width/channel length (W/L), Cᵢₙ₀ is the gate input capacitance of the minimum-size inverter, C_{ds0} is the drain-to-substrate capacitance of the minimum-size inverter Rᵢₙₜ is the line resistance per unit length of the signal transmission line, Cᵢₙₜ is the line capacitance per unit length of the signal transmission line, bᵣ is the number of branches, or a fan-out number, m is the driveability ratio between the output inverter and the input inverter in each buffer, and lᵢₙₜ is the length of the subject signal transmission line bridging two nodes.

In the conventional technique for inserting a group of successively-cascaded inverters (or buffers) in a signal transmission line of a semiconductor device, the driveability of each inverter is generally designed higher than the driveability of the preceding inverter. The driveability of the inverter generally depends on the channel ratio of the CMOSFET included in the inverter. For example, if first through third inverters are inserted in this order in a signal transmission line, it is usual that the second inverter has a higher driveability than the first inverter, whereas the third inverter has a higher driveability than the second inverter. In the case of a buffer having first and second inverters cascaded in this order, it is usual that the second inverter has a higher driveability than the first inverter. In other word, the value for “m” in the above formula satisfies the relationship m>1.

It is generally considered in the conventional technique that if an inverter has a higher driveability than the succeeding inverter in a buffer inserted in a signal transmission line, the buffer essentially has a higher input capacitance to delay the input signal supplied from the preceding-stage buffer, thereby causing a longer overall propagation delay of the signal transmission line. In addition, since the waveform of the input signal for the buffer has a distortion, or a dull edge, due to the higher input capacitance, the operational delay of the buffer also increases. In view of the current amplification function of the transistors of the preceding inverter, the transistors of the succeeding inverter should have a higher driveability than the transistors of the preceding inverter, to reduce the overall operational delay of the buffer. Thus, it is determined in the conventional technique that the succeeding inverter have a higher driveability than the preceding inverter in a buffer to reduce the overall signal propagation delay.

For determining the value for “m” providing a minimum signal propagation delay t_{d-bf} in formula (1), a partial differential equation is obtained from formula (1), as follows:

(−d)·Rᵢₙₜ·lᵢₙₜ·Cᵢₙ₀·h_{bf-out}/m⁻²−b·bᵣ·Rₒᵤₜ₀·C_{ds0}·N_{bf}/m⁻²+b·Rₒᵤₜ₀·C_{ds0}·N_{bf}=0.

By solving the above equation with respect to m², the following formula:

m²=bᵣ+(d·Rᵢₙₜ·lᵢₙₜ·Cᵢₙ₀·h_{bf-out})/(b·Rₒᵤₜ₀·C_{ds0}·N_{bf}) (2)

can be obtained. Since m>0 and bᵣ≧1 and:

(d·Rᵢₙₜ·lᵢₙₜ·Cᵢₙ₀·h_{bf-out})/(b·Rₒᵤₜ₀·C_{ds0}N_{bf})>0

satisfy in formula (2), the following relationship:

m={bᵣ+(d·Rᵢₙₜ·lᵢₙₜ·Cᵢₙ₀h_{bf-out})/(b·Rₒᵤₜ₀·C_{ds0}·N_{bf})}^{1/2}>1

is obtained.

Accordingly, the condition for the value “m” providing a minimum overall propagation delay is such that m>1 satisfies.

However, it is found by the present inventor that a repeater having the relationship, m>1, for the “m” in the formula (1) does not necessarily provide the minimum overall propagation delay if the signal transmission line disposed between two adjacent repeaters has a higher line capacitance, i.e., higher load. This is considered due to the fact that a higher line capacitance of the signal transmission line allows the input capacitance of the input inverter of the buffer, as viewed from the preceding-stage buffer, to be neglected relative to the higher line capacitance.

In view of the above, it is an object of the present invention to provide a repeater inserted in a signal transmission line, which is capable of reducing the overall propagation delay of the signal transmission line.

It is another object of the present invention to provide a semiconductor device including a plurality of repeaters inserted in a signal transmission line to reduce the overall propagation delay of the signal transmission line.

The present invention provides a repeater inserted in a signal transmission line, including first and second logic gates cascaded in this order along a direction of a signal transmission in the signal transmission line, each of the first and second logic gates having a logic inverting function, the first logic gate having a current driveability than a current driveability of the second logic gate.

The present invention also provides a semiconductor device including a signal transmission line and a plurality of repeaters inserted in the signal transmission line to divide the signal transmission line into a plurality of divided signal lines, each of the repeaters including first and second logic gates cascaded in this order along a direction of a signal transmission in the signal transmission line, each of the first and second logic gates having a logic inverting function, the first logic gate having a current driveability than a current driveability of the second logic gate.

In accordance with the repeater of the present invention and the repeater in the semiconductor device of the present invention, the signal transmission line including the repeater or repeaters has a smaller overall propagation delay due to the first logic gate having a higher current driveability than the second logic gate.

The above and other objects, features and advantages of the present invention will be more apparent from the following description, referring to the accompanying drawings.

### BRIEF DESCRIPTION OF THE DRAWINGS

FIG. 1 is a circuit diagram of a buffer used as a repeater according to an embodiment of the present invention, and FIG. 1B is a schematic logic diagram of the buffer of FIG. 1A, schematically illustrating different driveabilities of the inverters disposed therein.

FIG. 2 is an equivalent circuit diagram of a simulated signal transmission line which is measured for the overall propagation delay thereof.

FIG. 3 is a graph showing the relationship between the overall propagation delay and the pitch of repeaters inserted in the signal transmission line.

FIG. 4 is a block diagram of a clock tree system having repeaters in a semiconductor device according to another embodiment of the present invention.

FIG. 5 is a block diagram an example of a signal transmission line to which the present invention is applied.

FIG. 6 is a block diagram of another example of the repeater of the present invention.

FIG. 7 is a graph showing the relationship between the length of a signal transmission line and the propagation delay.

### PREFERRED EMBODIMENTS OF THE INVENTION

Now, the present invention is more specifically described with reference to accompanying drawings, wherein similar constituent elements are designated by similar reference numerals.

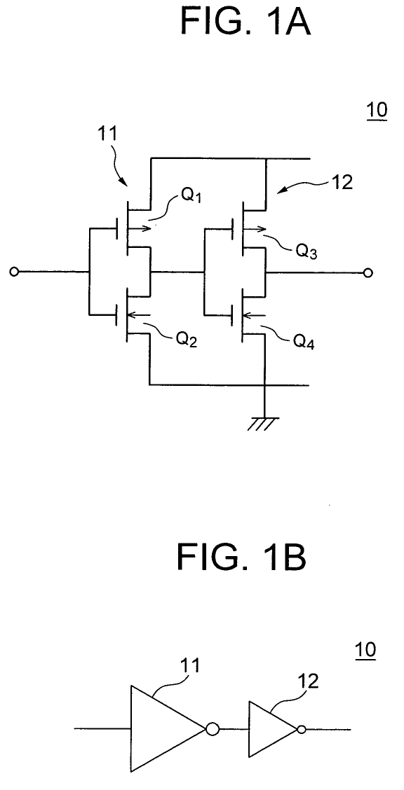

Referring to FIGS. 1A and 1B, a buffer (or repeater) according to an embodiment of the present invention includes a first inverter 11 implemented by a CMOSFET including a p-ch MOSFET Q1 and an n-ch MOSFET Q2, and a second inverter 12 cascaded from the first inverter 11 and implemented by a CMOSFET including a p-ch MOSFET Q3 and an n-ch MOSFET Q4. The first inverter 11 has a driveability (or current driveability) higher than the driveability of the second inverter 12, as schematically illustrated in FIG. 1B.

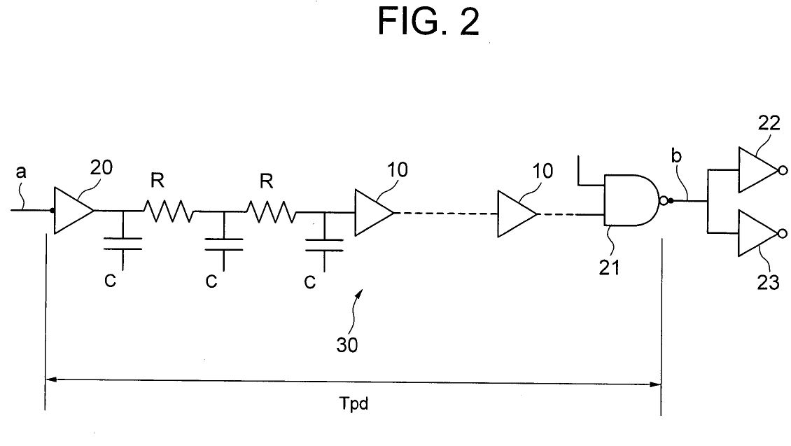

Referring to FIG. 2, there is shown an equivalent circuit diagram of a signal transmission line 30 simulated in the present invention by a simulator to detect the propagation delay thereof. The signal transmission line 30 is connected between a driver 20 and a NAND gate 21 and includes a plurality repeaters 10 inserted in the signal transmission line 30. The signal transmission line 30 may be preferably used between two functional blocks in an LSI. The signal transmission line 30 itself is illustrated as a π-distributed parameter system including series resistors R and parallel capacitors C. The simulator detects the propagation delay Tpd which is defined herein by a time interval between a first time instant at which an input signal is applied at a node “a” to the input of the driver 20 and a second time instant at which the corresponding signal is delivered through the NAND gate 21 at node “b”.

A rise propagation delay is defined by a time interval between the time instant at which the potential of node “a” exceeds a median potential between the potentials of L-level and H-level and the time instant at which the potential of node “b” falls below the median potential. Similarly, a fall propagation delay is defined by a time interval between the time instant at which the potential of node “a” falls below the median potential and the time instant at which the potential of node “b” exceeds the median potential. The overall propagation delay is defined by an average of the rise propagation delay and the fall propagation delay.

The driver 20 delivers an output signal having a polarity same as the polarity of the input signal, driving the signal transmission line 30 including a plurality of repeaters 10 inserted therein and the NAND gate 21 connected to the distal end thereof. Inverters 22 and 23 are connected in parallel to the output of the NAND gate 21, constituting the load of the NAND gate 21. The repeaters 10 are inserted at a constant pitch in the signal transmission line 30 between the driver 20 and the NAND gate 21, thereby equally dividing the signal transmission line 30 into a plurality of divided signal lines. This reduces the line length to be driven by the driver 20. The overall propagation delay of the signal transmission line 30 is the total of a sum of the propagation delays of the divided signal lines and a sum of the operational delays of the repeaters 10. The former increases in proportion to the square of the length of the divided signal lines, whereas the latter increases in proportion to the number of repeaters inserted. The circuit simulator iterates simulation of the signal transmission line while using a variety of parameters such as the number and the driveability ratio of the repeaters to be inserted, thereby obtaining an optimum configuration of the signal transmission line having an overall propagation delay within a desired range.

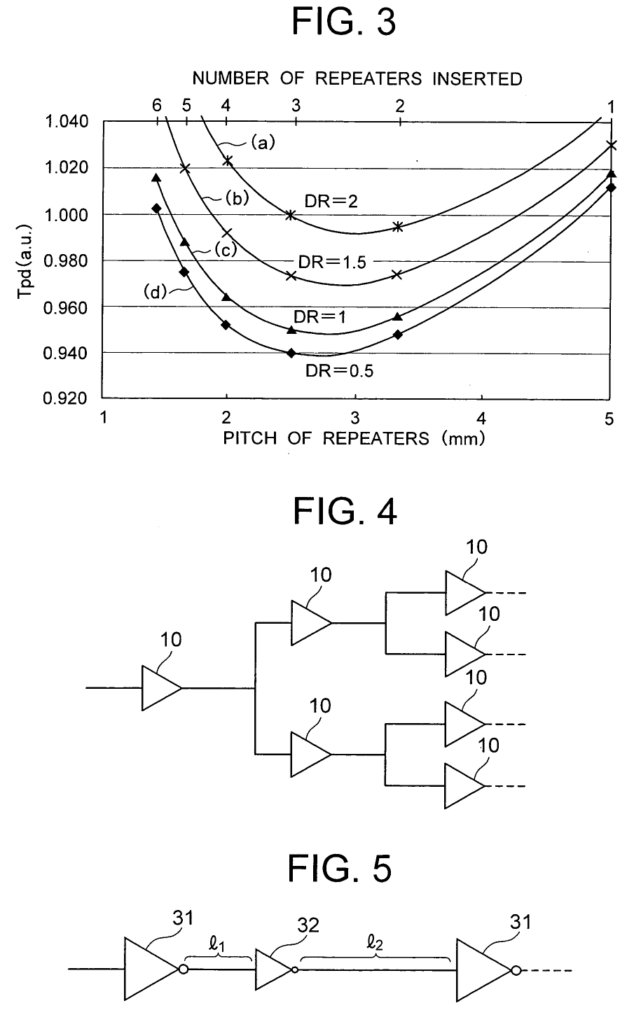

Referring to FIG. 3, there are shown graphs illustrating the relationships obtained by the simulation between the pitch (or number) of the repeaters inserted and the overall propagation delay, with the driveability ratio between the second inverter and the first inverter in the repeater being a parameter. The signal transmission line employed in the simulation was such that used in a 0.13-micrometer-generation semiconductor device, and had a length of 10 mm. In the simulation, the driveability ratio (DR: driveability of the second inverter/driveability of the first inverter) is changed by changing the driveability of the first inverter 11, with the driveability of the second inverter 12 being fixed, and the driveability of the first inverter 11 is changed by changing the gate width (W) of the MOSFETs therein, with the gate length (L) of the MOSFETs being fixed.

Graphs (a) to (d) in FIG. 3 show the overall propagation delays in the cases of driveability ratios (DR) of 2, 1.5, 1 and 0.5, respectively, for the repeaters. It is to be noted that the overall propagation delays are normalized in FIG. 3 by a specified overall propagation delay for the case where the pitch of the repeaters is 2.5 mm in graph (a), i.e., driveability ratio of 2.

In those exemplified graphs (a) to (d), the overall propagation delay is reduced when the number of repeaters is increased from 1 to 2, or when the pitch of the repeaters is decreased from 5 mm to 3.3 mm. This is because a larger number of repeaters reduce the length of the divided signal lines to reduce the loads of the driver 20 and the repeaters 10. More generally, for the case where the number of the repeaters is within the certain lower range, the overall propagation delay can be reduced by increasing the number of the repeaters inserted in the signal transmission line because the decrease of the propagation delays of the divided signal lines exceeds the increase of the operational delays of the repeaters.

In the example of FIG. 3, if the number of repeaters inserted is increased from 4 to 5. or from 5 to 6, the overall propagation delay is increased. This is because the increase of the operational delays of the repeaters by reducing the pitch of the repeaters exceeds the decrease of the propagation delays of the divided signal lines due to the decrease of the line length thereof. Thus, there is an optimum number or optimum pitch of the repeaters inserted, the optimum number being about 3 and the optimum pitch being about 2.5 in this example.

As understood from FIG. 3, the overall propagation delay is reduced along with the decrease of the driveability ratio in the repeater. It is general in the conventional technique to use a driveability ratio of around 2, at least higher than 1. However, in the embodiment of the present invention, a driveability ratio less than 1 is employed in the repeater to further reduce the overall propagation delay based on this finding.

If the first inverter 11 has a higher driveability than the second inverter in the repeater for the case where the length of the signal transmission line is within a smaller range and thus the line resistance and the line capacitance are within lower ranges contrary to the above case, the overall propagation delay is increased by using a repeater having a driveability ratio lower than 1. Thus, the conventional technique employs a driveability ratio higher than 1.

However, a signal transmission line connected between two functional blocks in a semiconductor device generally has a higher line capacitance due to a longer distance therebetween. In such a signal transmission line including therein repeaters, the capacitance of the divided signal lines is significantly higher than the input capacitance of the repeater connected thereto, which is often negligible with respect to the capacitance of the divided signal lines although the input impedance of the first inverter is higher in the present invention. The repeaters of the present invention are suitably used in such a signal transmission line.

More specifically, the capacitance of divided signal line and the input capacitance of the repeater distort the waveform of the signal transferred therethrough to reduce the slope of the rising or falling edge of the signal, thereby increasing the operational delays of the inverters in the repeater. Considering the case where a plurality of repeaters are inserted in a signal transmission line, if the capacitance of the divided signal line is significantly higher than the input capacitance of the first inverter in the repeater which receives a signal through the divided signal line, the distortion of the signal waveform caused by the line capacitance is dominant over the distortion of the signal waveform caused by the driveability of the first inverter. In this case, the slope of the rising or falling edge of the signal waveform delivered from the first inverter significantly depends on the driveability of the first inverter. Therefore, the slope of the rising or falling edge of the signal input to the second inverter is increased by the higher driveability of the first inverter, thereby reducing the operational delay of the second inverter. Thus, the repeater including the first inverter having a higher driveability reduces the signal propagation delay in a higher degree compared to the conventional repeater including a first inverter having a lower driveability, so long as the second inverters have a fixed driveability.

In the above embodiment, the output signal of the repeater 10 corresponds to the input signal thereof in a one-to-one correspondence. However, the repeater may have a plurality of fun-outs or branches at the output thereof. Referring to FIG. 4, there is shown a clock tree system including a repeater having a plurality of fun-outs at the output thereof according to another embodiment of the present invention. It is to be noted that the clock signal in a semiconductor device is generally delivered to separate functional blocks by using such a clock tree system. The clock tree system in a semiconductor device according to the present invention has therein a repeater having a driveability ratio lower than 1.

If two separate inverters are cascaded in a signal transmission line, the two inverters may be construed as a repeater. FIG. 5 shows such a signal transmission line, wherein first inverters 31 having a higher driveability and second inverters 32 having a lower driveability are alternately inserted in the signal transmission line to be cascaded from one another. In this example, the second inverter 32 is cascaded from the preceding first inverter 31 via a divided signal line having a length of L1 and is cascaded to the succeeding first inverter 31 via a divided signal line having a length of L2, which is longer than L1.

In the configuration shown in FIG. 5, the cascaded inverters 31 and 32 in pair can be referred to as a repeater according to the present invention, because the overall propagation delay of the signal transmission line can be reduced by the configuration, although this configuration is not necessarily best suited for obtaining a smaller propagation delay. In such a configuration, the length L2 should be significantly larger than the length L1, and more preferably, the length L1 should be small enough to be negligible compared to the input capacitance of the inverters 32 whereby the output capacitance as viewed from the inverter 31 is substantially equal to the gate input capacitance of the succeeding inverter 32.

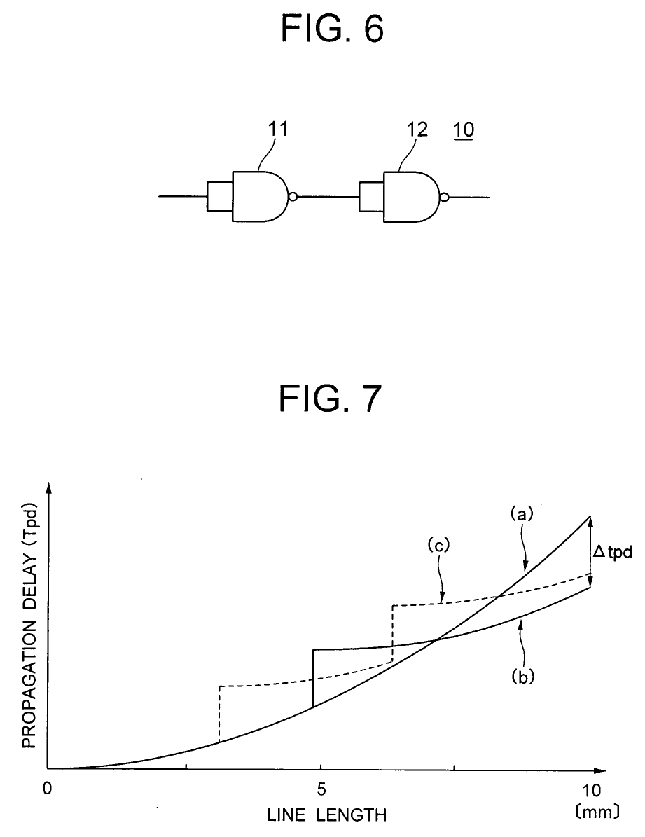

The repeater of the present invention is not limited to the repeater 10 shown in FIG. 1A, and may have a variety of configurations. FIG. 6 shows such an example, wherein the repeater 10A includes a pair of cascaded NAND gates 11A and 12A each having two inputs (or more) connected together. Each NAND gate 11A or 12A may be replaced by another logic gate having a logic inverting function. In a cell-base design of a semiconductor device, for example, if NAND gates are used as a basic cell, the repeater of the present invention may be preferably implemented by the NAND gates instead of the inverters shown in FIG. 1A.

Since the above embodiments are described only for examples, the present invention is not limited to the above embodiments and various modifications or alterations can be easily made therefrom by those skilled in the art without departing from the scope of the present invention.

What is claimed is:

1. A repeater inserted in a signal transmission line, comprising first and second logic gates cascaded in this order along a direction of a signal transmission in the signal transmission line, each of said first and second logic gate having a logic inverting function, said first logic gate having a current driveability than a current driveability of said second logic gate.

2. The repeater according to claim 1, wherein said repeater is inserted in a clock distribution line as said signal transmission line.

3. A semiconductor device comprising a signal transmission line and a plurality of repeaters inserted in said signal transmission line to divide said signal transmission line into a plurality of divided signal lines, each of said repeaters comprising first and second logic gates cascaded in this order along a direction of a signal transmission in said signal transmission line, each of said first and second logic gates having a logic inverting function, said first logic gate having a current driveability than a current driveability of said second logic gate.

4. The semiconductor device according to claim 3, wherein each of said divided signal lines is longer than an internal signal line connecting together said first and second inverters in each of said repeater.

5. The semiconductor device according to claim 3, further comprising a branch signal line and another repeater having an input connected to said branch line, said another repeater comprising third and fourth logic gates cascaded in this order and having a logic inverting function, said third logic gate having a current driveability than a current driveability of said fourth logic gate, one of said repeaters having an output connected to an input of another of said repeaters through one of said divided signal lines and said another repeater through said branch signal line.

6. The semiconductor device according to claim 5, wherein said signal transmission line is a clock distribution line.
